(19) United States
(12) Patent Application Publication
(10) Pub. No.: US 2020/0033885 A1
(43) Pub. Date: Jan. 30, 2020

(54) METHOD FOR CONTROLLING VEHICLE IN AUTONOMOUS DRIVING SYSTEM AND APPARATUS THEREOF

(71) Applicant: LG Electronics Inc., Seoul (KR)

(72) Inventor: Cheolseung KIM, Seoul (KR)

(21) Appl. No.: 16/588,936

(22) Filed: Sep. 30, 2019

(30) Foreign Application Priority Data
Aug. 20, 2019 (KR) 10-2019-0102015

(51) Int. Cl. G05D 1/02; G08G 1/00; G05D 1/00; B60W 30/18

(52) U.S. Cl. CPC G05D 1/0291; G08G 1/22; G05D 1/0088; B60W 30/18; G05D 2201/0213; B60W 2520/10; B60W 2530/10; B60W 2550/40; B60W 2550/14; B60W 2550/308

(57) ABSTRACT

Disclosed is a method for controlling platooning by a control vehicle in an autonomous driving system.

More specifically, the control vehicle acquires driving information from each of a plurality of vehicles performing the platooning, wherein the driving information comprises first distance information related to a distance by which each of the plurality of vehicles slips in a road in a vertical direction and second distance information related to a distance by which each of the plurality of vehicles slips in a road in a horizontal direction

In addition, the control vehicle transmits, based on the first distance information and the second distance information, transmit control information for controlling a speed and a position of each of the plurality of vehicles to each of the plurality of vehicles.

### CROSS-REFERENCE TO RELATED APPLICATIONS

This application claims the benefit of Korea Patent Application No. 10-2019-0102015 filed on Aug. 20, 2019, which is incorporated herein by reference for all purposes as if fully set forth herein.

### BACKGROUND OF THE INVENTION

### Field of the Invention

The present invention relates to a method and an apparatus for controlling a vehicle in an autonomous driving system, and more particularly to a method and an apparatus for controlling platooning formation in accordance with a road condition in an autonomous driving system by which a plurality of vehicles drives in a platoon.

### Related Art

A vehicle may be classified as an internal engine vehicle, an external combustion engine vehicle, a gas turbine vehicle, or an electric vehicle by a type of engine.

An autonomous vehicle refers to a vehicle capable of driving on its own even without manipulation by a driver or a passenger, and an autonomous driving system refers to a system that monitors and controls the autonomous vehicle so that the autonomous vehicle can drive on its own.

In the autonomous driving system, a plurality of vehicle may form a platoon, and the vehicles in the platoon may exchange information through vehicle-to-everything (V2X) communication and thus drive in a predetermined platooning formation. In addition, if autonomous vehicles perform platooning in a chess-shaped platoon formation, the platooning formation may break due to a travel hindrance, such as ice on road, and a collision between vehicles may occur.

### SUMMARY OF THE INVENTION

The present invention aims to address the aforementioned necessity and/or problem.

In addition, the present invention is to provide a vehicle control method and apparatus for preventing breakdown of a platooning formation of platooning vehicles due to a travel hindrance or collision between the vehicles.

In addition, the present invention is to provide a vehicle control method and apparatus for controlling a position and a speed of a vehicle in a platoon based on vertical slipping and horizontal slipping of the vehicle, which is predicted by taking into consideration of characteristics of the vehicle and received from vehicles forming a platoon during platooning.

In addition, the present invention is to provide a vehicle control method and apparatus, by which a control vehicle is allowed to recognize a road condition in advance through communication with a server during platooning, and performs platooning by controlling each of vehicles forming a platoon in accordance with the recognized road condition.

Technical subjects obtainable from the present invention are non-limited by the above-mentioned technical task. And, other unmentioned technical tasks can be clearly understood from the following description by those having ordinary skill in the technical field to which the present invention pertains.

In one general aspect of the present invention, there is provided a method for controlling platooning by a control vehicle in an autonomous driving system, the method including: acquiring driving information from each of a plurality of vehicles performing the platooning, wherein the driving information comprises first distance information related to a distance by which each of the plurality of vehicles slips in a road in a vertical direction and second distance information related to a distance by which each of the plurality of vehicles slips in a road in a horizontal direction; and, based on the first distance information and the second distance information, transmitting control information for controlling a speed and a position of each of the plurality of vehicles to each of the plurality of vehicles.

The driving information further may include weight information on a weight of each of the plurality of vehicles.

The method may further include: based on the driving information, calculating a position of each of the plurality of vehicles in the platooning, inter-vehicle distance of the plurality of vehicles, and a speed of each of the plurality of vehicles, wherein the control information comprises at least one of position information related to the calculated position, inter-vehicle distance information related to the calculated inter-vehicle distance, or speed information related to the calculated speed.

The method may further include: transmitting a request message to a server to request road information related to road characteristics along a driving route; and receiving a response message including the road information from the server.

The road information may include ice information indicating presence of ice on the driving route, and state information indicating a state of a road.

The method may further include, based on the road information, transmitting a platooning request message, which instructs that at least one special vehicle for a specific duty performs the platooning, to the at least one special vehicle.

The at least one special vehicle may be at a leading position of the platooning.

The method may further include transmitting, to the plurality of vehicles, an instruction message for instructing driving on a lane on which the at least one special vehicle is driving.

The method may further include comparing the first distance information and the second distance information with a minimum threshold value and a maximum threshold value.

When the first distance information and the second distance information are smaller than the minimum threshold value, the control information may indicate that there is no change in speeds and positions of the plurality of vehicles.

When the first distance information and the second distance information are greater than the minimum threshold value and smaller than the maximum threshold value, the control information may include information on a change in the inter-vehicle distance of the plurality of vehicles, speed change information, and information on a change in a position of a vehicle in the platooning.

When the first distance information and the second distance information are greater than the maximum threshold value, the platooning may be released or a route of the platooning may be changed.

In another general aspect of the present invention, there is provided a control vehicle for controlling platooning in an autonomous driving system, the vehicle including: a transmitter and a receiver to communicate with a server; and a processor functionally connected to the transmitter and the receiver, wherein the processor is configured to: acquire driving information from each of a plurality of vehicles performing the platooning, wherein the driving information comprises first distance information related to a distance by which each of the plurality of vehicles slips in a road in a vertical direction and second distance information related to a distance by which each of the plurality of vehicles slips in a road in a horizontal direction; and, based on the first distance information and the second distance information, transmit control information for controlling a speed and a position of each of the plurality of vehicles to each of the plurality of vehicles.

The driving information further may include weight information on a weight of each of the plurality of vehicles.

The processor may be further configured to: based on the driving information, calculating a position of each of the plurality of vehicles in the platooning, inter-vehicle distance of the plurality of vehicles, and a speed of each of the plurality of vehicles, and wherein the control information comprises at least one of position information related to the calculated position, inter-vehicle distance information related to the calculated inter-vehicle distance, or speed information related to the calculated speed.

The processor may be further configured to: transmit a request message to a server to request road information related to road characteristics along a driving route; and receive a response message including the road information from the server.

The road information may include ice information indicating presence of ice on the driving route, and state information indicating a state of a road.

The processor may be further configured to, based on the road information, transmit a platooning request message, which instructs that at least one special vehicle for a specific duty performs the platooning, to the at least one special vehicle.

The at least one special vehicle may be at a leading position of the platooning.

The processor is configured to: transmit, to the plurality of vehicles, an instructing message for driving on a lane in which the at least one special vehicle is driving.

### BRIEF DESCRIPTION OF THE DRAWINGS

The accompanying drawings, which are included herein as a part of the description for help understanding the present invention, provide embodiments of the present invention, and describe the technical features of the present invention with the description below.

FIG. 1 shows an example of a block diagram of a wireless communication system to which methods proposed in the present invention can be applied.

FIG. 2 shows an example of a method for transmitting and receiving signals in a wireless communication system.

FIG. 3 shows an example of a basic operation between a user terminal and a 5G network in a 5G communication system.

FIG. 4 shows an example of a basic operation between vehicles using 5G communication.

FIG. 5 is a diagram showing a vehicle according to an embodiment of the present invention.

FIG. 6 is a control block diagram of a vehicle according to an embodiment of the present invention.

FIG. 7 is a control block diagram of an autonomous vehicle according to an embodiment of the present invention.

FIG. 8 is a signal flowchart of an autonomous vehicle according to an embodiment of the present invention.

FIG. 9 is a diagram referred to in describing a use scenario of a user according to an embodiment of the present invention.

FIG. 10 is an example of vehicle-to-everything (V2X) communication to which the present invention can be applied.

FIG. 11 shows an example of a method for allocating a resource in a sidelink where V2X is used.

FIG. 12 shows an example of platooning in an autonomous driving system according to an embodiment of the present invention.

FIG. 13 shows an example of a method for calculating driving information of a vehicle performing platooning in an autonomous driving system according to an embodiment of the present invention.

FIGS. 14 and 15 show an example of changing platooning formation by a control vehicle in an autonomous driving system according to an embodiment of the present invention.

FIG. 16 shows an example of a method for changing platooning formation by a control vehicle in an autonomous driving system according to an embodiment of the present invention.

FIG. 17 shows an example of a method for determining platooning formation through communication with a server in an autonomous driving system according to an embodiment of the present invention.

FIG. 18 shows an example of a method for determining platooning formation based on a road condition in an autonomous driving system according to an embodiment of the present invention.

FIG. 19 shows an example of a method for changing platooning formation based on driving information of a vehicle in accordance with a road condition according to an embodiment of the present invention.

FIG. 20 shows another example of a method for changing platooning formation based on driving information of a vehicle in accordance with a road condition according to an embodiment of the present invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

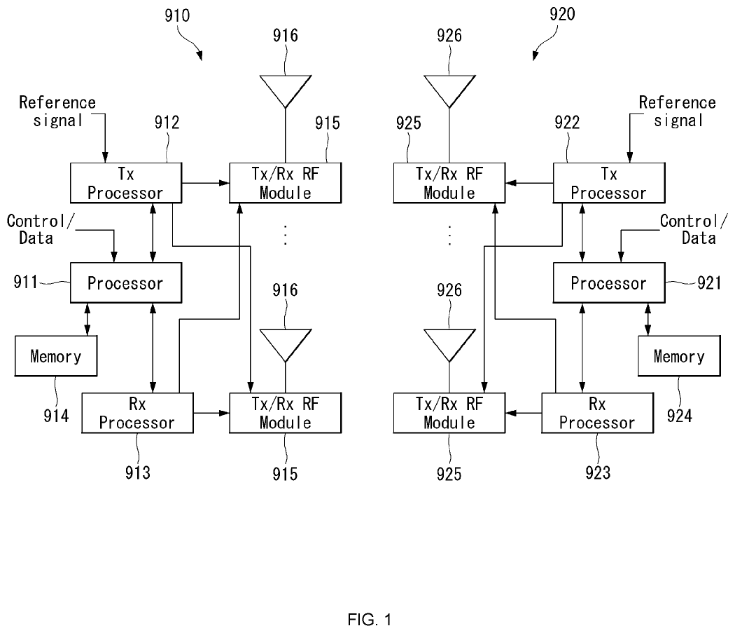

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

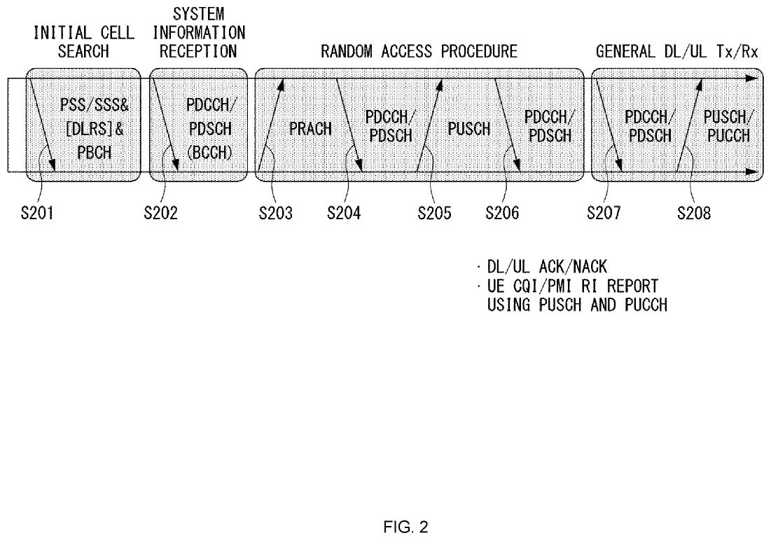

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

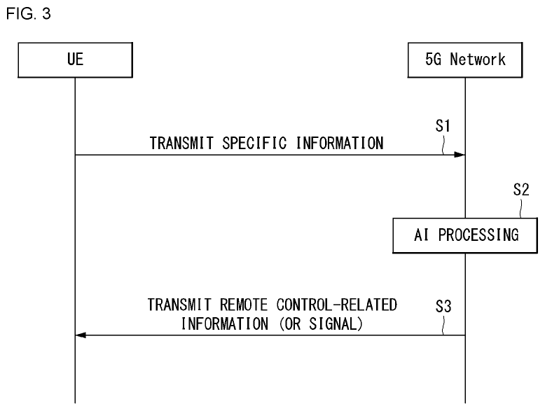

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

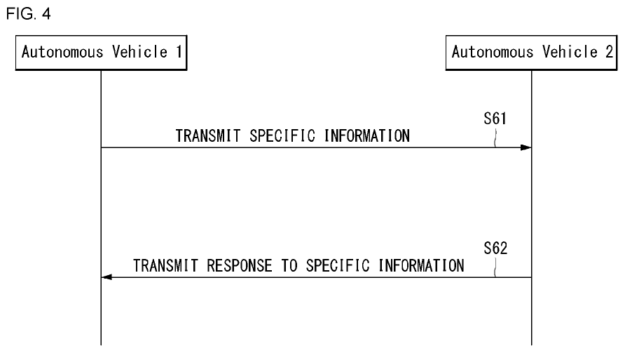

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

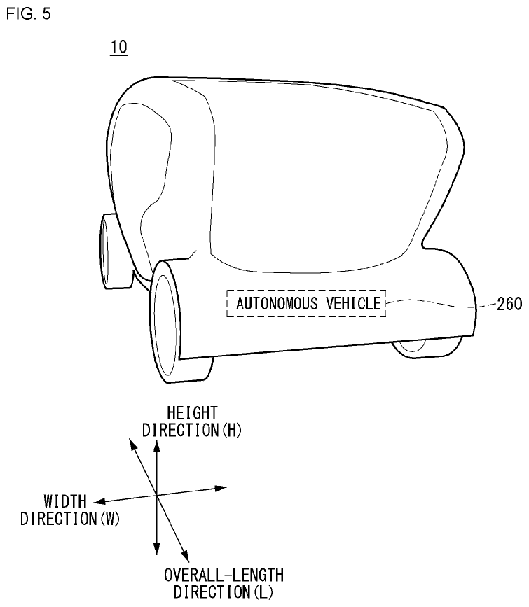

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

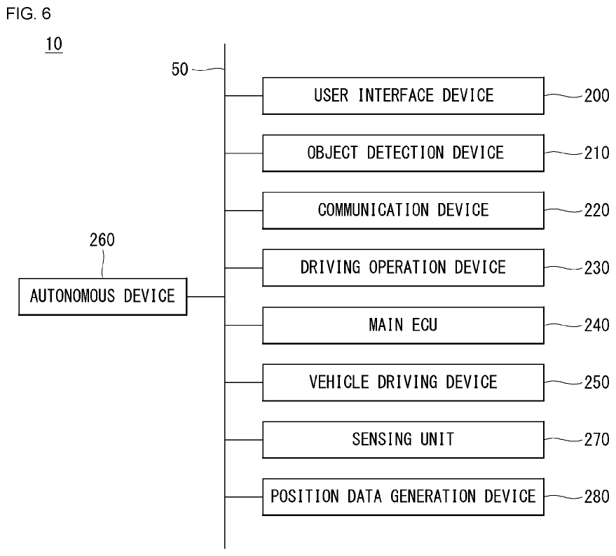

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

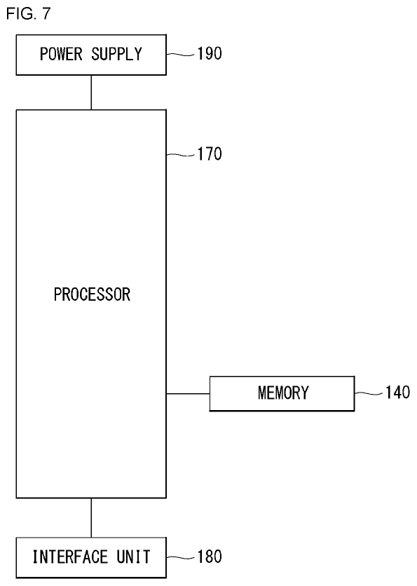

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

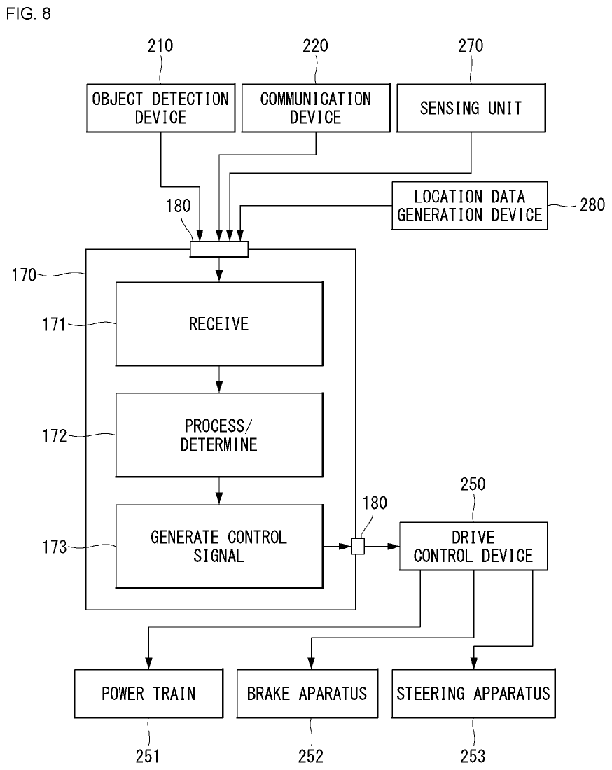

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Autonomous Vehicle Usage Scenarios

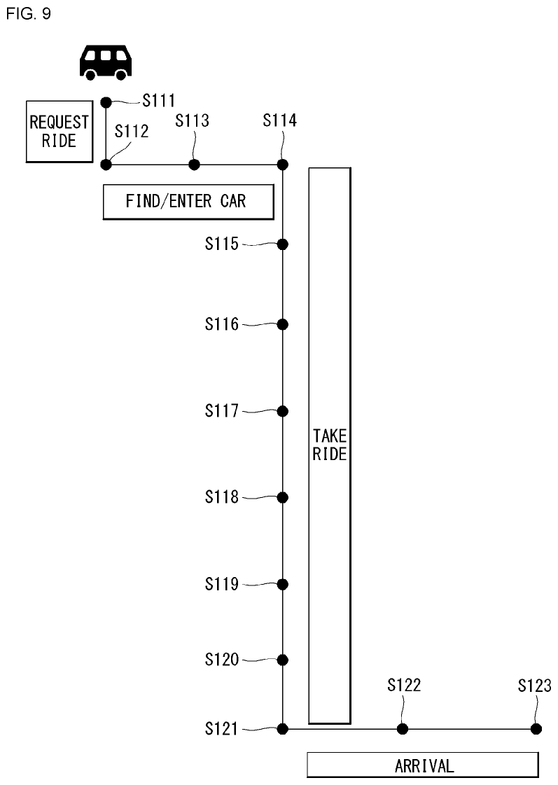

FIG. 9 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

V2X (Vehicle-to-Everything)

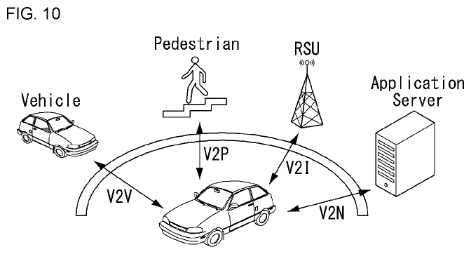

FIG. 10 illustrates V2X communication to which the present invention is applicable.

V2X communication includes communication between a vehicle and any entity, such as V2V (Vehicle-to-Vehicle) referring to communication between vehicles, V2I (Vehicle to Infrastructure) referring to communication between a vehicle and an eNB or a road side unit (RSU), V2P (Vehicle-to-Pedestrian) referring to communication between a vehicle and a UE carried by a person (a pedestrian, a bicycle driver, or a vehicle driver or passenger), and V2N (vehicle-to-network).

V2X communication may refer to the same meaning as V2X sidelink or NR V2X or refer to a wider meaning including V2X sidelink or NR V2X.

V2X communication is applicable to various services such as forward collision warning, automated parking system, cooperative adaptive cruise control (CACC), control loss warning, traffic line warning, vehicle vulnerable safety warning, emergency vehicle warning, curved road traveling speed warning, and traffic flow control.

V2X communication can be provided through a PC5 interface and/or a Uu interface. In this case, specific network entities for supporting communication between vehicles and every entity can be present in wireless communication systems supporting V2X communication. For example, the network entities may be a BS (eNB), a road side unit (RSU), a UE, an application server (e.g., traffic safety server) and the like.

Further, a UE which performs V2X communication may refer to a vehicle UE (V-UE), a pedestrian UE, a BS type (eNB type) RSU, a UE type RSU and a robot including a communication module as well as a handheld UE.

V2X communication can be directly performed between UEs or performed through the network entities. V2X operation modes can be categorized according to V2X communication execution methods.

V2X communication is required to support pseudonymity and privacy of UEs when a V2X application is used such that an operator or a third party cannot track a UE identifier within an area in which V2X is supported.

The terms frequently used in V2X communication are defined as follows.
RSU (Road Side Unit): RSU is a V2X service enabled device which can perform transmission/reception to/from moving vehicles using a V2I service. In addition, the RSU is a fixed infrastructure entity supporting a V2X application and can exchange messages with other entities supporting the V2X application. The RSU is a term frequently used in conventional ITS specifications and is introduced to 3GPP specifications in order to allow documents to be able to be read more easily in ITS industry. The RSU is a logical entity which combines V2X application logic with the function of a BS (BS-type RSU) or a UE (UE-type RSU).
V2I service: A type of V2X service having a vehicle as one side and an entity belonging to infrastructures as the other side.
V2P service: A type of V2X service having a vehicle as one side and a device carried by a person (e.g., a pedestrian, a bicycle rider, a driver or a handheld UE device carried by a fellow passenger) as the other side.
V2X service: A 3GPP communication service type related to a device performing transmission/reception to/from a vehicle.
V2X enabled UE: UE supporting V2X service.
V2V service: A V2X service type having vehicles as both sides.
V2V communication range: A range of direct communication between two vehicles participating in V2V service.

V2X applications called V2X (Vehicle-to-Everything) include four types of (1) vehicle-to-vehicle (V2V), (2) vehicle-to-infrastructure (V2I), (3) vehicle-to-network (V2N) and (4) vehicle-to-pedestrian (V2P) as described above.

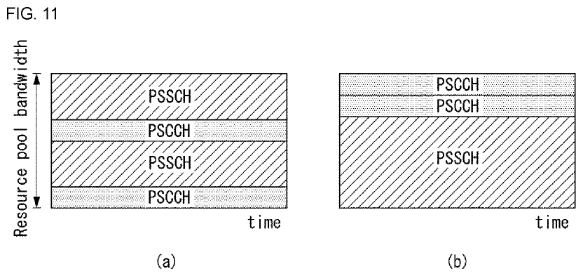

FIG. 11 illustrates a resource allocation method in siderink in which V2X is used.

On sidelink, different physical sidelink control channels (PSCCHs) may be spaced and allocated in the frequency domain and different physical sidelink shared channels (PSSCHs) may be spaced and allocated. Alternatively, different PSCCHs may be continuously allocated in the frequency domain and PSSCHs may also be continuously allocated in the frequency domain.

NR V2X

To extend 3GPP platform to auto industry during 3GPP release 14 and 15, support for V2V and V2X services has been introduced in LTE.

Requirements for support for enhanced V2X use cases are arranged into four use example groups.

(1) Vehicle platooning enables dynamic formation of a platoon in which vehicles move together. All vehicles in a platoon obtain information from the leading vehicle in order to manage the platoon. Such information allows vehicles to travel in harmony rather than traveling in a normal direction and to move together in the same direction.

(2) Extended sensors allow vehicles, road side units, pedestrian devices and V2X application servers to exchange raw data or processed data collected through local sensors or live video images. A vehicle can enhance recognition of environment beyond a level that can be detected by a sensor thereof and can ascertain local circumstances more extensively and generally. A high data transfer rate is one of major characteristics.

(3) Advanced driving enables semi-automatic or full-automatic driving. Each vehicle and/or RSU share data recognized thereby and obtained from local sensors with a neighboring vehicle, and a vehicle can synchronize and adjust a trajectory or maneuver. Each vehicle shares driving intention with a neighboring traveling vehicle.

(4) Remote driving enables a remote driver or a V2X application to drive a remote vehicle for a passenger who cannot drive or cannot drive a remote vehicle in a dangerous environment. When changes are limited and routes can be predicted such as public transportation, driving based on cloud computing can be used. High reliability and low latency time are major requirements.

The above-described 5G communication technology may apply in conjunction with methods proposed in the present invention, or may be supplemented to further specify or clarify technical feature of the methods proposed in the present invention.

Hereinafter, a method and an apparatus for controlling a vehicle in an autonomous driving system according to an embodiment of the present invention will be described.

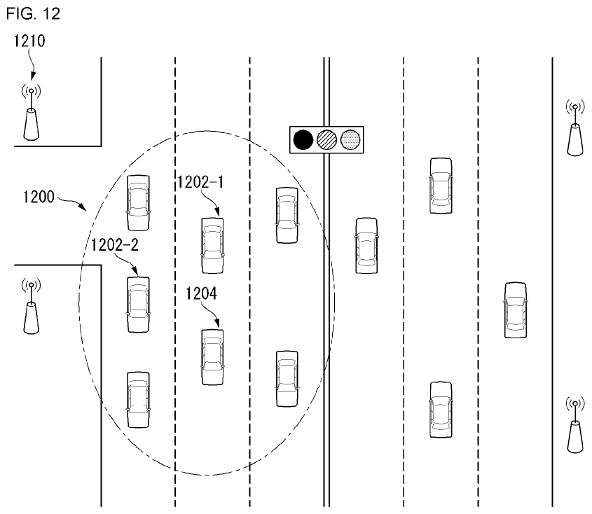

FIG. 12 shows an example of platooning in an autonomous driving system according to an embodiment of the present invention.

Platooning in an autonomous driving system refers to a plurality of vehicles driving in a group on a road under the same control. That is, the platooning may include a platoon 1200 of vehicles subject to the same control, a plurality of platooning vehicles 1202-1 and 1202-2, a control vehicle 1204 controlling a driving operation of the plurality of vehicles in the platooning, and a server (or base station) 1201 performing communication to perform platooning of the control vehicle 1204 and the plurality of vehicles 1202-1 and 1202-2.

The control vehicle 1204 may transmit a control message for platooning to each of the plurality of vehicles 1202-1 and 1202-2 to control a speed and a position of each of the plurality of vehicles 1202-1 and 1202-2, so that the plurality of vehicles 1202-1 and 1202-2 can perform platooning.

In addition, the control vehicle 1204 may acquire information necessary for platooning through communication with the server 1201, and report a state of each vehicle to the server 1201.

In a case of controlling the plurality of vehicles in platooning, when a specific event occurs in each of the plurality of vehicles 1202-1 and 1202-2 (for example, breakdown, accident, or slipping), the control vehicle 1202 cannot reflect this specific event in the platooning and thereby the plurality of vehicles 1202-1 and 1202-2 may collide.

For example, if autonomous vehicles are platooning in a chessboard-shaped formation on an icy road or the like, the vehicles may collide depending on a degree of a vehicle.

Therefore, the present invention proposes a method for changing platooning formation by acquiring driving information of each vehicle when a plurality of vehicles are platooning.

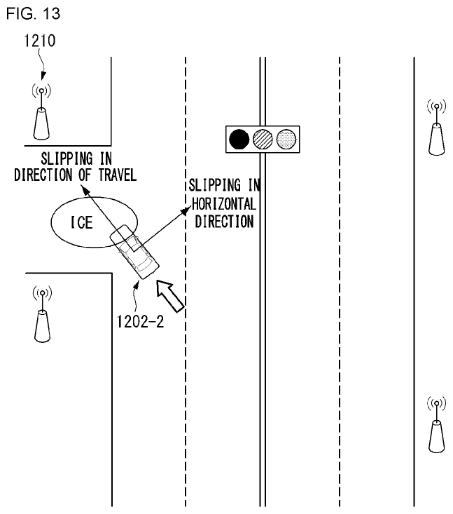

FIG. 13 shows an example of a method for calculating driving information of a platooning vehicle in an autonomous driving system according to an embodiment of the present invention.

Referring to FIG. 13, a control vehicle may acquire driving information from each of a plurality of vehicles forming a platoon, and control platooning formation based on the acquired driving information.

Specifically, a control vehicle for controlling overall platooning may acquire driving information related to a driving operation according to a road condition from each of a plurality of vehicles forming a platoon.

For example, in a case where there is ice on a road, driving information may include first distance information related to a distance by which a vehicle has slipped in a direction of travel (or a vertical direction), and second information related to a distance by which the vehicle has slipped in a horizontal direction.

Each vehicle 1202-2 forming a platoon may use a sensor to measure distances of slipping in the horizontal direction and the direction of travel of the vehicle when the vehicle travels in an area such as an icy area.

In this case, when a slipping distance is equal to or greater than a threshold value, first distance information and second information, which are related to a degree of slipping in the horizontal direction and the vertical direction (a slip ratio to a speed) are calculated based on a weight, a velocity vector, or the like of each vehicle.

Each vehicle 1202-2 may transmit driving information including the calculated first distance information and the second distance information to the control vehicle, and the driving information may further include weight information indicative of a weight of the vehicle 1202-2 and may be repeatedly transmitted at a predetermined period (e.g., 10 seconds).

In this case, distances of slipping in the direction of travel and in the horizontal direction may be calculated by comparing the current coordinates of the vehicle and coordinates at which the vehicle is expected to be positioned in t seconds.

Specifically, the vehicle calculates the coordinates at which the vehicle is expected to be positioned in t seconds, by taking into consideration of the current speed at the current coordinates (measured using a Global Positioning System (GPS) or the like). Then, the vehicle may measure distances by which the vehicle has slipped in the vertical direction and the horizontal direction, by comparing coordinates at which the vehicle is actually positioned after t seconds and the coordinates at which the vehicle was predicted to be positioned in t seconds, and may calculate a slip ratio based on the measured slip distance.

The control vehicle 1204 may change platooning formation based on the driving information received from the plurality of vehicles 1202-2 forming a platoon.

That is the control vehicle 1204 may determine platooning formation by taking into consideration of slipping in the horizontal direction, slipping in the vertical direction, a weight, a speed, and the like of each vehicle forming a platoon.

Specifically, the control vehicle 1204 may calculate a position of each of the plurality of vehicles in a platoon, inter-vehicle distances of the plurality of vehicles, and a speed of each of the plurality of vehicles, based on the driving information received from the plurality of vehicles 1202-2, and may transmit, to each of the plurality of vehicles, control information that includes position information related to the calculated position, inter-vehicle distance information related to the calculated inter-vehicle distances, and/or speed information related to the calculated speed.

Upon receiving the control information from the control vehicle 1204, each of the plurality of vehicles 1202-2 may change a travel speed and a position of a corresponding vehicle in the platooning, based on the control information.

In this case, the control vehicle 1204 may predict a distance by which the plurality of vehicles 1202-2 slips in t seconds, using Equation 1, as below.

$$Predicted slip distance = \frac{speed ( km \text{/} h ) \times slip ratio \times T ( seconds )}{3600 ( seconds )} \qquad [ Equation 1 ]$$

For example, the control vehicle 1204 predicts a degree of slipping of each vehicle, and, when each vehicle slips, the control vehicle 1204 may transmit a control message, which instructs to change a speed, a position, and the like of each vehicle, to each vehicle so as to prevent a collision.

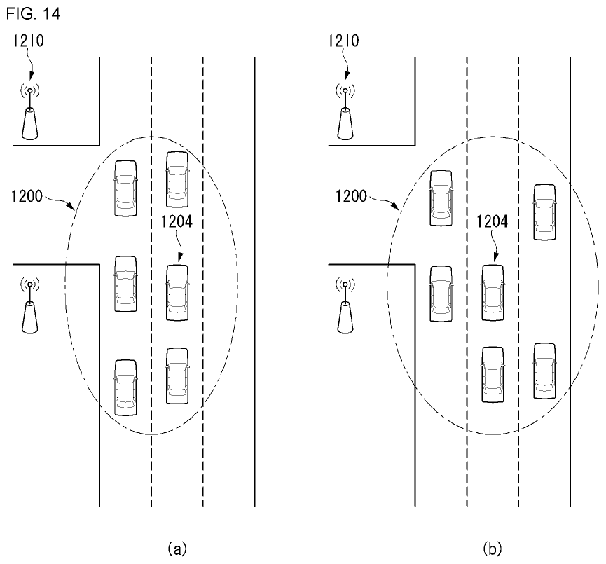

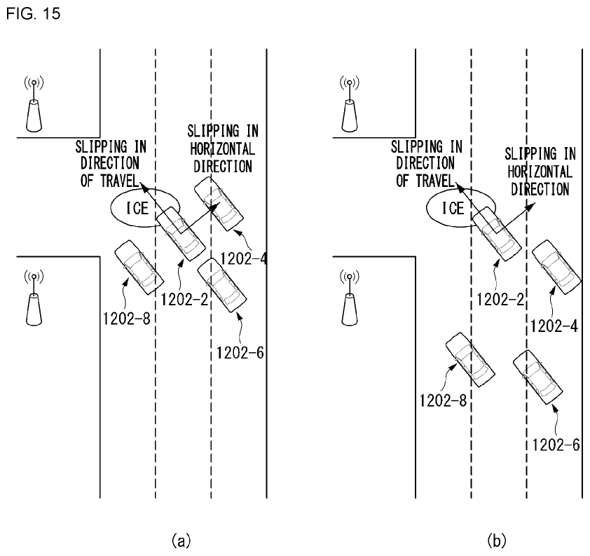

FIGS. 14 and 15 show an example of a method by which a control vehicle changes platooning formation in an autonomous driving system according to an embodiment of the present invention.

Referring to FIGS. 14 and 15, when the control vehicle determines that it is necessary to change platooning formation, as described above in FIG. 13, the control vehicle may change the platooning formation by transmitting a control message, which instructs to change a speed and a position, to each vehicle forming a platoon.

Specifically, as described above in FIG. 13, the control vehicle may acquire driving information from each vehicle forming a platoon, and change platooning formation based on the driving information.

For example, as shown in (a) of FIG. 14, in a case where platooning vehicles are positioned in density and thus inter-vehicle distances are short, the control vehicle 1204 may determine that there is a possibility of collision between the vehicles, based on driving information acquired from each of the vehicles.

In this case, the control vehicle 1204 may transmit a control message instructing change of a speed and a position of each vehicle to each vehicle, as described above in FIG. 13, determine platooning formation in consideration of a degree of slipping of each vehicle, as described in (b) of FIG. 13, and thereby change platooning formation.

In this case, upon receiving the control message, each vehicle may change a speed and a position in the platooning, as shown in (b) of FIG. 13.

Specifically, as shown in (a) of FIG. 15, the control vehicle 1204 may acquire driving information, described in FIG. 13, from a plurality of vehicles 1202-2, 1202-4, 1202-6, and 1202-8 involved in the platooning.

Based on the control vehicle 1204, the control vehicle 1204 may acquire first distance information, related to a distance by which a first vehicle 1202-2 has slipped on an icy road in a direction of travel, and second distance information, related to a distance by which the first vehicle 1202-2 has slipped on the icy road in a horizontal direction. Based on the first distance information and the second distance information, the control vehicle 1204 may predict a degree of slipping of the first vehicle 1202-2 on the icy road.

Next, by predicting the degree of slipping of the first vehicle 1202-2, the control vehicle 1204 may change positions of the vehicles 1202-4, 1202-6, and 1202-6.

That is, the control vehicle 1204 may predict a degree of slipping of the first vehicle 1202-2, and, in a case where a second vehicle 1202-4 and a fourth vehicle 1202-8 are within a distance within which there is a possibility of collision with the first vehicle 1202-2, the control vehicle 1204 may change positions of the second vehicle 1202-4 and the fourth vehicle 1204-8 to other positions in the platoon, as shown in (b) of FIG. 15.

To this end, the control vehicle 1204 may transmit control information, which includes position information indicative of positions to be changed and/or speed information indicative of speeds to be changed, to the second vehicle 1202-4 and the fourth vehicle 1202-8, and thereby the control vehicle 1204 may instruct the second vehicle 1202-4 and the fourth vehicle 1202-8 to change the positions and/or speeds.

Likewise, the control vehicle 1204 may predict a distance by which the first vehicle 1202-2 slips in the vertical direction, and, in a case where a third vehicle 1202-6 is located within a distance in which there is a possibility of collision with the first vehicle 1202-2, the control vehicle 1204 may change the position of the third vehicle 1202-6 to another position in the platoon, as shown in (b) of FIG. 15.

To this end, the control vehicle 1204 may transmit control information, which includes position information indicative of a position to be changed and/or speed information indicative of a speed to be changed, to the third vehicle 1202-6, and thereby the control vehicle 1204 may instruct the third vehicle 1202-6 to change the position and/or speed.

In this manner, the control vehicle 1204 may predict a possibility of collision between vehicles forming a platoon based on driving information of the vehicles, and may prevent the collision between the vehicles by changing positions and speed of the vehicles accordingly.

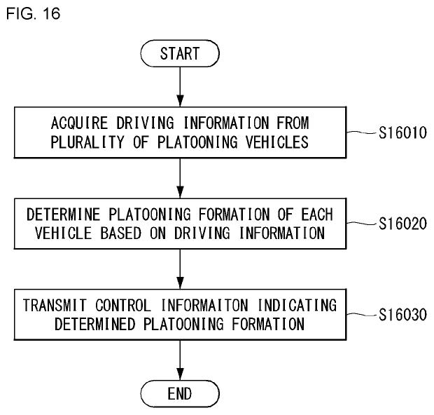

FIG. 16 shows an example of a method by which a control vehicle changes platooning formation in an autonomous driving system according to an embodiment of the present invention.

Referring to FIG. 16, based on driving information acquired from a plurality of platooning vehicles, a control vehicle may control platooning formation by controlling a position and a speed of each of the plurality of platooning vehicles.

Specifically, the control vehicle for controlling platooning may periodically acquire driving information from the plurality of platooning vehicles (S1610). For example, the plurality of platooning vehicles may transmit driving information, described in FIG. 13, to the control vehicle at 10 seconds.

The driving information refers to information related to a driving operation of each vehicle, and may include a length by which a corresponding vehicle slips on an icy road in a horizontal direction, a length by which the corresponding vehicle slips on the icy road in a vertical direction, and a weight of the corresponding vehicle.

Then, the control vehicle may determine platooning formation of each vehicle forming in a platoon, based on the acquired driving information (S16020).

That is, the control vehicle may predict a subsequent operation of each vehicle based on driving information acquired from a corresponding vehicle, and may determine platooning formation by changing a speed/position of each of a plurality of platooning vehicles according to a result of prediction in order to prevent a collision and the like.

For example, the control vehicle may calculate distances by which a vehicle to control slips on an icy road in the horizontal direction and the vertical direction, based on driving information, and may predict a length by which each vehicles slips on the icy road based on a result of the calculation.

The control vehicle determine an inter-vehicle distance, a position, and/or a speed for each of the plurality of platooning vehicles based on predicted information in order to prevent collision between the plurality of platooning vehicles, and may determine platooning formation according to the determined inter-vehicle distance, the determined position, and/or the determined speed.

In order to control platooning to be performed in the determine platooning formation, the control vehicle may transmit a control message which instructs a position, an inter-vehicle distance, and a speed (S1630), as described above in FIG. 15.

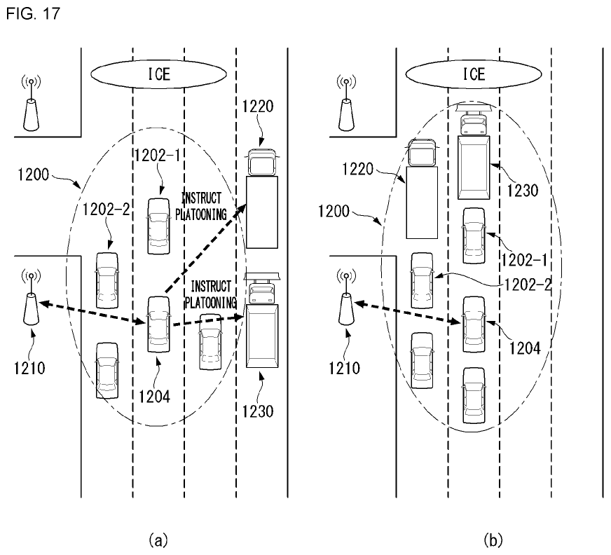

FIG. 17 shows an example of a method for determining platooning formation in an autonomous driving system through communication with a server according to an embodiment of the present invention.

Referring to FIG. 17, a control vehicle may determine a road condition through communication with the server, and, when there is a factor that may hinder traveling of a vehicle, the control vehicle may instruct a specific operation to address the interrupting factor.

Specifically, a control vehicle 1204 may acquire road information related to characteristics of a road on a travel route through the communication with a server 1210.

In this case, the control vehicle 1204 may periodically acquire road information of the road from the server 1210, transmit a request message to request the road information from the server 1210, and receive a response message including the road information with respect to the request message.

The road information may include a plurality of information items, which are necessary for the vehicle to travel on the road by performing platooning.

For example, the road information may include ice information indicating damage of a road and presence of ice on a travel route, state information indicating a condition of the road, accident information indicating occurrence of an accident, and/or event information indicating an event occurring on the road.

In this case, whether there is ice on the road may be determined based on factors as below.
Measure the reflectance of light on the road: the reflection of ice
Measurement of a slip ratio: A case where a difference between RPM and an actual distance travelled is equal to or greater than a specific ratio (e.g., 10%).
A case where a distance of slipping on a curved road in a horizontal distance is equal to or greater than a specific length (e.g., 30 cm or longer).
Measurement of indoor temperature: temperature at 0° C. or lower
Measurement of infrared sensor: Road surface temperature at 0° C. or lower
Result of camera image: No lane information
Whether the above-described information broadcasted by nearby V2X vehicles coincide with each other.

The control vehicle may change platooning formation based on road information, so that the platooning can be performed smoothly.

For example, as shown in (a) of FIG. 17, after recognizing that there is ice on a travel route based on road information, the control vehicle 1204 may acquire vehicle information of nearby vehicles capable of removing the ice.

The vehicle information may be r Table 1, as below.

TABLE 1

| Name of Route | Direction | Lane No. | Gear | Ice |
|---|---|---|---|---|
| Route 1 | Northern | 1 | Chain | Breaking |
| Route 2 | Northern | 1 | Snowplow | Pushing Aside |
| | | | Car | |
| Route 3 | Northern | 1 | Large- | Melting |
| | | | sized Car | |
| | | | (Freight | |
| | | | Car) | |

The control vehicle 1204 may instruct a first special vehicle 1220 and a second special vehicle 1230, capable of removing ice, to perform platooning based on the vehicle information.

Then, as shown in (b) of FIG. 17, the first special vehicle 1220 and the second special vehicle 1230 may participate in platooning and may be located at a leading position on a lane to thereby remove a travel hindrance.

In this case, the control vehicle 1204 may transmit an instruction message, which instructs to travel in a lane in which the first special vehicle 1220 and the second special vehicle 1230 are traveling, to a plurality of vehicles 1202-1 and 1202-2, and the plurality of vehicles 1202-1 and 1202-2 may travel on the lane in which the first special vehicle 1220 and the second special vehicle 1230 are traveling.

In this manner, it is possible to recognize and remove a travel hindrance existing on a travel route while platooning is performed.

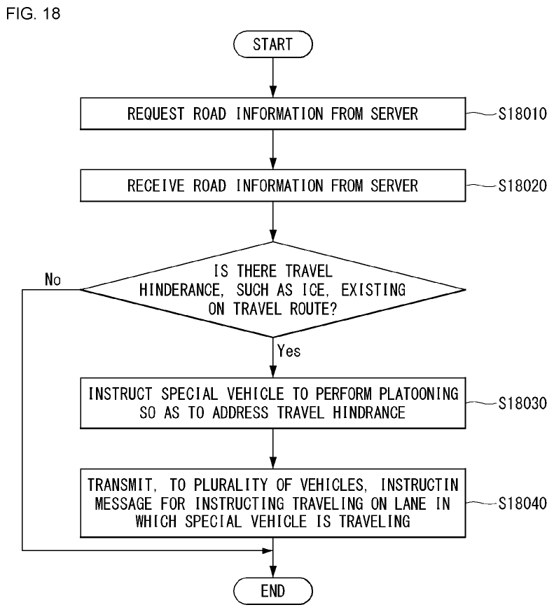

FIG. 18 shows an example of a method for determining platooning formation in an autonomous driving system based on a road condition according to an embodiment of the present invention.

Referring to FIG. 18, a control vehicle may determine platooning formation based on road information acquired from a server.

Specifically, the control vehicle may transmit a request message for requesting transmission of road information on a road from the server (S18010).

In this case, the request message may include an identifier for identifying a requested road, an identifier for identifying a road in which the control vehicle is now driving, etc.

Then, the control vehicle may receive a response message, including the road information, from the server with respect to the request message (S18020).

The road information may include a plurality of information items, which is necessary for a vehicle to travel on a road through platooning.

For example, the road information may include ice information indicating damage of a road and presence of ice on a travel route, state information indicating a condition of the road, accident information indicating occurrence of an accident, and/or event information indicating an event occurring on the road.

Based on the road information, the control vehicle may recognize whether a platooning hindrance, such as ice, exists on a travel route along which the control vehicle is now traveling.

For example, whether a platooning hindrance is present on the travel route, the control vehicle may change platooning formation based on the road information, so that the platooning can be performed smoothly.

For example, when it is recognized based on the road information that ice is present on a route of platooning, the control vehicle may acquire vehicle information of nearby vehicles capable of removing the ice, and then instruct a special vehicle, capable of removing a travel hindrance, to perform platooning based on the acquired vehicle information (S18030).

In this case, vehicle information may be the same as Table 1, and the control vehicle may instruct platooning to the special vehicle, by transmitting an instruction message for instructing the special vehicle to perform platooning.

In addition, the control vehicle may transmit a request message for requesting participation of the special vehicle in platooning and controlling of the special vehicle, and the server may transmit a control message, which instructs platooning to the special vehicle and indicates that the control vehicle has a control right, to the special vehicle.

In addition, the server may transmit a response message, which indicates whether the special vehicle is platoonable and controllable, to the control vehicle.

In a case where the special vehicle joins platooning, the special vehicle may perform platooning at a position where to remove an interrupting factor.

For example, in a case where there is ice on a road, the special vehicle may perform platooning at a leading position in a lane where the ice is present so as to remove the interrupting factor.

In this case, the special vehicle may be a snowplow car or a freight truck.

When the vehicle joins the platooning, the control vehicle may transmit an instruction message, which instructs a plurality of platooning vehicle to travel on a lane in which the special vehicle is traveling, to the plurality of platooning vehicles (S18040).

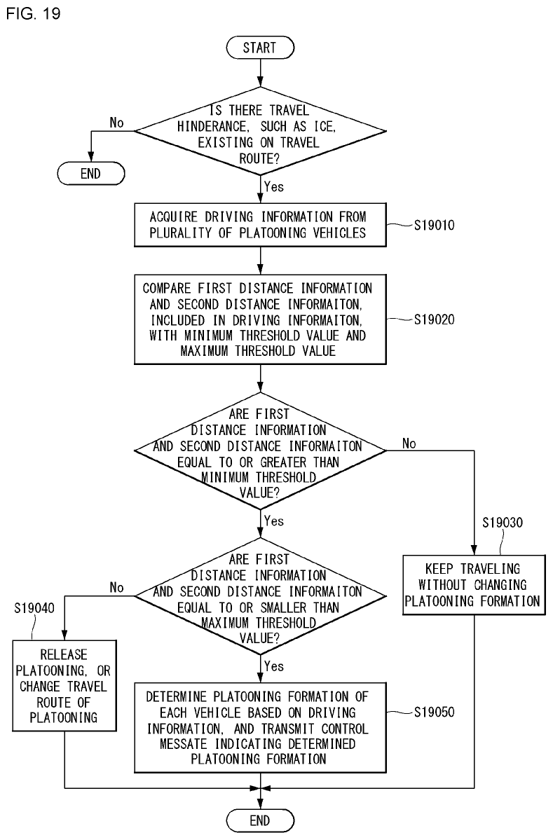

FIG. 19 shows an example of a method for changing a form of a platoon based on driving information of a vehicle in accordance with a road condition according to an embodiment of the present invention.

Referring to FIG. 19, a control vehicle may determine whether to change platooning formation or whether to keep performing platooning, based on driving information of platooning vehicles.

First, it is assumed that the steps S18010 and S18020 of FIG. 18 have been already performed.

Specifically, after acquiring road information from a server, a control vehicle may recognize whether a travel hindrance, such as ice, is present on a travel route, and, when the travel interrupting factor is present, the control vehicle may acquire driving information, described in FIG. 13, from a plurality of platooning vehicles (S19010).

The driving information may be acquired upon a request from the control vehicle or may be periodically transmitted by the plurality of vehicles to the control vehicle.

Then, the control vehicle may compare first distance information and second distance information, which are included in the driving information, with a minimum threshold value and a maximum threshold value, and may control platooning based on a result of the comparison.

In this case, the minimum threshold value indicates a minimum value of a slipping length which enables a corresponding vehicle to travel normally, and the maximum threshold value indicates a maximum value of a slipping length which enables the corresponding vehicle to perform platooning.

Specifically, when the first distance information and the second distance information are equal to or smaller than the minimum threshold value, the control vehicle determines that platooning is possible even without changing a speed, a position, and/or an inter-vehicle distance for each vehicle, and keeps platooning without changing platooning formation (S19030).

However, when the first distance information and the second distance information is greater than a minimum threshold value and smaller than a maximum threshold value, the control vehicle may determine platooning formation of each platooning vehicle based on the driving information, and transmit a control message indicating the determined platooning formation (S19050).

Specifically, when it is determined that each vehicle is likely to slip on ice and a collision is likely to occur, the control vehicle may change platooning formation by instructing change of a speed, a position, and/or an inter-vehicle distance for each vehicle or by instructing joining in platooning by a special vehicle performing a special duty and lane change of vehicles.

For example, the control vehicle may transmit a control message instructing change of a position, a speed, and/or an inter-vehicle distance for each vehicle in the same method described in FIGS. 13 to 16, or may transmit a control message instructing joining in platooning by a special vehicle or lane change of vehicles in the same method described in FIG. 17, so that platooning formation to remove an interrupting factor existing from a travel route can be changed.

However, when the first distance information and the second distance information are greater than the maximum threshold value, the control vehicle may determine that platooning is not possible on the current travel route, and thus the control vehicle may release platooning so that each vehicle can drive individually or may change a travel route (S19040).

In the case of changing a travel route of platooning, the control vehicle transmits a request message for requesting a detour route from a server, and receives a response message.

When the response message includes route information related to the detour route, the control vehicle may change the travel route to the detour route so as to keep platooning.

Yet, when the response message does not include route information related to the detour route (that is, when there is no detour route), the control vehicle may release platooning.

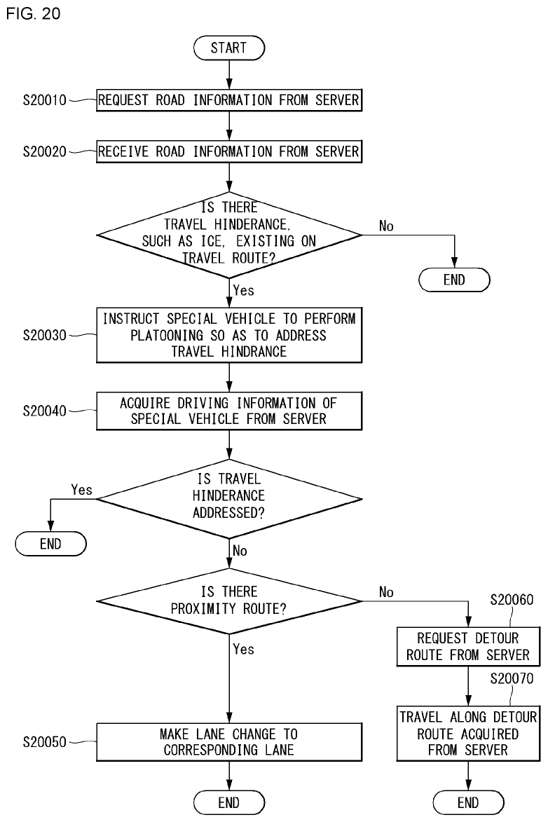

FIG. 20 shows another example of a method for changing platooning formation based on driving information of a vehicle in accordance with a road condition according to an embodiment of the present invention.

First, a control vehicle may transmit a request message for requesting transmission of road information on a road from a server (S20010).

In this case, the request message may include an identifier for identifying a requested road, an identifier for identifying a road in which the control vehicle is now driving, etc.

Then, the control vehicle may receive a response message, including the road information, from the server with respect to the request message (S20020).

The road information may include a plurality of information items, which is necessary for a vehicle to travel on a road through platooning.

For example, the road information may include ice information indicating damage of a road and presence of ice on a travel route, state information indicating a condition of the road, accident information indicating occurrence of an accident, and/or event information indicating an event occurring on the road.

Based on the road information, the control vehicle may recognize whether a platooning interrupting factor, such as ice, exists on a travel route along which the control vehicle is now traveling.

For example, whether a platooning interrupting factor (e.g., ice) is present on the travel route, the control vehicle may acquire vehicle information of nearby vehicles capable of removing ice and may instruct platooning to a special vehicle capable of removing a travel hindrance based on the acquired vehicle information (S20030).

In this case, the vehicle information may be the same as in Table 1.

Then, the control vehicle may acquire driving information of the special vehicle from a server, and recognize whether the travel interrupting factor is addressed, based on the driving information.

For example, the server measures a slip ratio of the special vehicle, and, when a measurement of the slip ratio has not improved by a specific rate (e.g., 30%), the server may determine that the interrupting factor has not been addressed.

In this case, the server may release platooning of special vehicles and request platooning from normal vehicles again.

Then, the control vehicle may acquire driving information regarding the platooning of the normal vehicles, and measure a slip ratio for each lane to thereby determine whether there is a proximity route (another lane) where an interrupting factor has been addressed.

When there is a proximity route, the control vehicle may change platooning formation by transmitting a control vehicle instructing change to a corresponding lane to vehicles.

However, when there is no proximity route, the control vehicle may transmit a request message for requesting a route from a server (S20060), and receive a response message.

When the response message includes route information related to a detour route, the control vehicle may change a travel route to the detour route and thus keep platooning (S20070).

However, when the response message does not include route information related to a detour route (that is, when there is no detour route), the control vehicle may release platooning.

Hereinafter, various embodiments for controlling a vehicle in an autonomous driving system according to an embodiment of the present invention will be described.

### Embodiment 1

A method for controlling platooning by a control vehicle in an autonomous driving system, the method including: acquiring driving information from each of a plurality of vehicles performing the platooning, wherein the driving information comprises first distance information related to a distance by which each of the plurality of vehicles slips in a road in a vertical direction and second distance information related to a distance by which each of the plurality of vehicles slips in a road in a horizontal direction; and, based on the first distance information and the second distance information, transmitting control information for controlling a speed and a position of each of the plurality of vehicles to each of the plurality of vehicles.

### Embodiment 2

Regarding Embodiment 1, the driving information further may include weight information on a weight of each of the plurality of vehicles.

### Embodiment 3

Regarding Embodiment 1, the method may further include: based on the driving information, calculating a position of each of the plurality of vehicles in the platooning, inter-vehicle distance of the plurality of vehicles, and a speed of each of the plurality of vehicles, wherein the control information comprises at least one of position information related to the calculated position, inter-vehicle distance information related to the calculated inter-vehicle distance, or speed information related to the calculated speed.

### Embodiment 4

Regarding Embodiment 1, the method may further include: transmitting a request message to a server to request road information related to road characteristics along a driving route; and receiving a response message including the road information from the server.

### Embodiment 5

Regarding Embodiment 4, the road information may include ice information indicating presence of ice on the driving route, and state information indicating a state of a road.

### Embodiment 6

Regarding Embodiment 5, the method may further include, based on the road information, transmitting a platooning request message, which instructs that at least one special vehicle for a specific duty performs the platooning, to the at least one special vehicle.

### Embodiment 7

Regarding Embodiment 6, the at least one special vehicle may be at a leading position of the platooning.

### Embodiment 8

Regarding Embodiment 6, the method may further include transmitting, to the plurality of vehicles, an instruction message for instructing driving on a lane on which the at least one special vehicle is driving.

### Embodiment 9

Regarding Embodiment 1, the method may further include comparing the first distance information and the second distance information with a minimum threshold value and a maximum threshold value.

### Embodiment 10

Regarding Embodiment 9, when the first distance information and the second distance information are smaller than the minimum threshold value, the control information may indicate that there is no change in speeds and positions of the plurality of vehicles.

### Embodiment 11

Regarding Embodiment 9, when the first distance information and the second distance information are greater than the minimum threshold value and smaller than the maximum threshold value, the control information may include information on a change in the inter-vehicle distance of the plurality of vehicles, speed change information, and information on a change in a position of a vehicle in the platooning.

### Embodiment 12

Regarding Embodiment 9, when the first distance information and the second distance information are greater than the maximum threshold value, the platooning may be released or a route of the platooning may be changed.

### Embodiment 13

a control vehicle for controlling platooning in an autonomous driving system, the vehicle including: a transmitter and a receiver to communicate with a server; and a processor functionally connected to the transmitter and the receiver, wherein the processor is configured to: acquire driving information from each of a plurality of vehicles performing the platooning, wherein the driving information comprises first distance information related to a distance by which each of the plurality of vehicles slips in a road in a vertical direction and second distance information related to a distance by which each of the plurality of vehicles slips in a road in a horizontal direction; and, based on the first distance information and the second distance information, transmit control information for controlling a speed and a position of each of the plurality of vehicles to each of the plurality of vehicles.

### Embodiment 14

Regarding Embodiment 13, the driving information further may include weight information on a weight of each of the plurality of vehicles.

### Embodiment 15

Regarding Embodiment of 13, the processor may be further configured to: based on the driving information, calculating a position of each of the plurality of vehicles in the platooning, inter-vehicle distance of the plurality of vehicles, and a speed of each of the plurality of vehicles, and wherein the control information comprises at least one of position information related to the calculated position, inter-vehicle distance information related to the calculated inter-vehicle distance, or speed information related to the calculated speed.

### Embodiment 16

Regarding Embodiment 13, the processor may be further configured to: transmit a request message to a server to request road information related to road characteristics along a driving route; and receive a response message including the road information from the server.

### Embodiment 17

Regarding Embodiment 16, the road information may include ice information indicating presence of ice on the driving route, and state information indicating a state of a road.

### Embodiment 18

Regarding Embodiment 17, the processor may be further configured to, based on the road information, transmit a platooning request message, which instructs that at least one special vehicle for a specific duty performs the platooning, to the at least one special vehicle.

### Embodiment 19

Regarding Embodiment 18, the at least one special vehicle may be at a leading position of the platooning.

### Embodiment 20

Regarding Embodiment 18, the processor is configured to: transmit, to the plurality of vehicles, an instruction message for instructing driving on a lane on which the at least one special vehicle is driving.

### Embodiment 21

Regarding Embodiment 13, the processor is further configured to compare the first distance information and the second distance information with a minimum threshold value and a maximum threshold value.

### Embodiment 22

Regarding Embodiment 21, When the first distance information and the second distance information are smaller than the minimum threshold value, the control information may indicate that there is no change in speeds and positions of the plurality of vehicles.

### Embodiment 23

Regarding Embodiment 21, when the first distance information and the second distance information are greater than the minimum threshold value and smaller than the maximum threshold value, the control information may include information on a change in the inter-vehicle distance of the plurality of vehicles, speed change information, and information on a change in a position of a vehicle in the platooning.

### Embodiment 24

Regarding Embodiment 21, when the first distance information and the second distance information are greater than the maximum threshold value, the platooning may be released or a route of the platooning may be changed.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

The following are effects of a method and an apparatus for controlling a vehicle in an autonomous driving system according to an embodiment of the present invention.

When there is travel hindrance existing on a road (e.g., ice, an obstacle, and the like), the present invention may determine whether each vehicle is likely to malfunction according to the travel hindrance and may determine platooning formation.

In addition, as platooning formation is determined according to the travel hindrance, it is possible to prevent collision between vehicles and platooning formation break.

The technical effects of the present invention are not limited to the technical effects described above, and other technical effects not mentioned herein may be understood to those skilled in the art from the description below.

What is claimed is:

1. A method for controlling platooning by a control vehicle in an autonomous driving system, the method comprising;
acquiring driving information from each of a plurality of vehicles performing the platooning,
wherein the driving information comprises first distance information related to a distance by which each of the plurality of vehicles slips in a road in a vertical direction and second distance information related to a distance by which each of the plurality of vehicles slips in a road in a horizontal direction; and
transmitting control information for controlling a speed and a position of each of the plurality of vehicles to each of the plurality of vehicles based on the first distance information and the second distance information.

2. The method of claim 1, wherein the driving information further comprises weight information on a weight of each of the plurality of vehicles.

3. The method of claim 1, further comprising,
calculating a position of each of the plurality of vehicles in the platooning, inter-vehicle distance of the plurality of vehicles, and a speed of each of the plurality of vehicles based on the driving information,
wherein the control information comprises at least one of position information related to the calculated position, inter-vehicle distance information related to the calculated inter-vehicle distance, or speed information related to the calculated speed.

4. The method of claim 1, further comprising:
transmitting a request message to a server to request road information related to road characteristics along a driving route; and
receiving a response message including the road information from the server.

5. The method of claim 4, wherein the road information comprises ice information indicating presence of ice on the driving route, and state information indicating a state of a road.

6. The method of claim 5, further comprising, transmitting a platooning request message, which instructs that at least one special vehicle for a specific duty performs the platooning, to the at least one special vehicle based on the road information.

7. The method of claim 6, wherein the at least one special vehicle is at a leading position of the platooning.

8. The method of claim 6, further comprising transmitting, to the plurality of vehicles, an instruction message for instructing driving on a lane on which the at least one special vehicle is driving.

9. The method of claim 1, further comprising comparing the first distance information and the second distance information with a minimum threshold value and a maximum threshold value.

10. The method of claim 9, wherein when the first distance information and the second distance information are smaller than the minimum threshold value, the control information indicates that there is no change in speeds and positions of the plurality of vehicles.

11. The method of claim 9, wherein when the first distance information and the second distance information are greater than the minimum threshold value and smaller than the maximum threshold value, the control information comprises information on a change in the inter-vehicle distance of the plurality of vehicles, speed change information, and information on a change in a position of a vehicle in the platooning.

12. The method of claim 9, wherein when the first distance information and the second distance information are greater than the maximum threshold value, the platooning is released or a route of the platooning is changed.

13. A control vehicle for controlling platooning in an autonomous driving system, the vehicle comprising:
a transmitter and a receiver to communicate with a server; and
a processor functionally connected to the transmitter and the receiver,
wherein the processor is configured to:
acquire driving information from each of a plurality of vehicles performing the platooning, wherein the driving information comprises first distance information related to a distance by which each of the plurality of vehicles slips in a road in a vertical direction and second distance information related to a distance by which each of the plurality of vehicles slips in a road in a horizontal direction; and
transmit control information for controlling a speed and a position of each of the plurality of vehicles to each of the plurality of vehicles based on the first distance information and the second distance information.

14. The control vehicle of claim 13, wherein the driving information further comprises weight information on a weight of each of the plurality of vehicles.

15. The control vehicle of claim 13,
wherein the processor is further configured to, calculating a position of each of the plurality of vehicles in the platooning, inter-vehicle distance of the plurality of vehicles, and a speed of each of the plurality of vehicles based on the driving information, and
wherein the control information comprises at least one of position information related to the calculated position, inter-vehicle distance information related to the calculated inter-vehicle distance, or speed information related to the calculated speed.

16. The control vehicle of claim 13, wherein the processor is further configured to:
transmit a request message to a server to request road information related to road characteristics along a driving route; and
receive a response message including the road information from the server.

17. The control vehicle of claim 16, wherein the road information comprises ice information indicating presence of ice on the driving route, and state information indicating a state of a road.

18. The control vehicle of claim 17, wherein the processor is further configured to, based on the road information, transmit a platooning request message, which instructs that at least one special vehicle for a specific duty performs the platooning, to the at least one special vehicle.

19. The control vehicle of claim 18, wherein the at least one special vehicle is at a leading position of the platooning.

20. The control vehicle of claim 18, wherein the processor is configured to: transmit, to the plurality of vehicles, an instruction message for instructing driving on a lane on which the at least one special vehicle is driving.
